(19) United States
(12) Patent Application Publication
(10) Pub. No.: US 2026/0008391 A1
(43) Pub. Date: Jan. 8, 2026

(54) CUSHION PART AND VEHICLE SEAT

(71) Applicant: Adient US LLC, Plymouth, MI (US)

(72) Inventors: Ahmed OUALKADI, Velbert (DE); Francois MOUGIN, Barr (FR); Benoit DOYEN, Strasbourg (FR); Pawan Sanjeev TEMKAR, Pune (IN); Balaji Govindrao PATIL, Pune (IN); Laurent HUGUES, Soultz Les Baines (FR); Jean-Luc HAMM, Hoerdt (FR)

(21) Appl. No.: 19/328,541

(22) Filed: Sep. 15, 2025

Related U.S. Application Data
(63) Continuation-in-part of application No. 18/044,240, filed on Mar. 7, 2023, now Pat. No. 12,420,460.

(30) Foreign Application Priority Data
Sep. 29, 2020 (DE) 10 2020 125 382.6
Feb. 1, 2021 (DE) 10 2021 102 229.0

(51) Int. Cl. B60N 2/64; B60N 2/56; B60N 2/66; B60N 2/90

(52) U.S. Cl. CPC B60N 2/646; B60N 2/5642; B60N 2/66; B60N 2/976

(57) ABSTRACT

A cushion part for a vehicle seat may have a foam body having a first surface forming a seating surface and an opposite second surface, and a three-dimensionally shaped textile layer arranged on the second surface of the foam body and forming a backside of the foam body. The textile layer may have a seating support surface and two side bolsters.

### FIELD

The invention relates to a cushion part for a vehicle seat having a foam body and a textile layer. The invention furthermore relates to a vehicle seat.

There is a known practice of using cushion parts for vehicle seats which serve to cushion a seat structure and are intended to offer a user of the vehicle seat the best possible seating comfort.

### BACKGROUND

WO 2009/036841 A1 discloses a backrest for a vehicle seat in a motor vehicle, wherein the backrest is formed from a one-piece or multi-piece, padded wire frame. The wire frame gives a foam body of the cushion part the necessary stiffness.

WO 2014/106592 A1 discloses a cushion part, in particular for a vehicle seat, having a first foam layer facing a user and a second foam layer facing away from the user, wherein the first foam layer has a different hardness and/or density than the second foam layer, wherein the first foam layer has a plurality of comfort tubes facing the user. The first foam layer may be separated from the second foam layer by a mesh structure, in particular made of polyethylene, jute, gauze or nonwoven.

There is a known practice in the prior art of providing cushion parts for upholstery parts made of polyurethane foams with a reinforcement on their underside, which is supported on a bearing frame or supporting frame of the object to be upholstered when the upholstery part is used. Such a reinforcement must, in particular, be wear-resistant and tear-resistant in order to prevent damage to or destruction of the cushion part, as may occur due to the use of the upholstery part and to the associated repeated stresses and movements on the bearing frame or supporting frame.

PU cushion parts known from the prior art, in particular for backrests or seating parts, are not rigid enough to be implemented on their own in a seat environment. Therefore, additional support by a load-bearing seat structure is always required. Such a seat structure may be made of metal or of plastic. Therefore, vehicle seats known from the prior art consist of a seat structure and a cushion part carried by the seat structure. The seat structure usually has a very high weight, is expensive and takes up installation space, but this is often scarce. Cushion parts ensure comfort. The structural parts of the seat ensure the necessary structural support of the cushion parts.

Overmolding a frame or a reinforcing material with foam to increase rigidity is also known in practice. However, such foam-overmolded components either cause problems with the production process or are difficult or cost-intensive.

The underlying object of the invention is that of improving a cushion part of the type mentioned at the outset with reduced thickness and improved support and rigidity. This is intended to provide the possibility of constructing a vehicle seat which is lighter and more comfortable than the prior art and which, moreover, requires less installation space. In particular, it is an object to replace an in-molded wire frame for a cushion part, which, although it increases the rigidity of the cushion part, is heavy and cost-intensive.

It is also the underlying object of the invention to provide a lightweight and low-cost vehicle seat having a cushion part according to the invention.

The object is achieved by a cushion part according to the features of claim 1 and by a vehicle seat according to the features of claim 13.

Preferred exemplary embodiments of the invention are given in the dependent claims.

### SUMMARY

According to the invention, this object is achieved by a cushion part, in particular for a vehicle seat, comprising a foam body which has a first surface forming a seating surface and an opposite second surface, and a three-dimensionally shaped textile layer arranged on the second surface of the foam body and forming a backside of the foam body, wherein the textile layer comprises a seating support surface and two side bolsters and a plurality of reinforcement ribs is provided on at least one of a region of the seating support surface, an inner surface of the side bolsters, or an outer surface of the side bolsters, wherein each of the reinforcement ribs forms a respective first receiving space.

The cushion part according to the invention enables an integration of functional seat structures, in particular components, such as blower units and ventilation ducts, in a structurally stable and space-efficient manner. Further, the cushion part according to the invention improves mechanical support of the seat without increasing overall thickness of the cushion part, thereby allowing for a flat seat design. Furthermore, the invention seeks to enhance occupant comfort by enhancing knee room and avoiding pressure peaks caused by local hard spots.

In particular, the functional seat structures/components, e.g. components, such as blower units and ventilation ducts, may be integrated or attached directly to a textile layer, e.g. a 3D-shaped textile layer. The 3D-shaped textile layer, e.g. a shell fleece, may comprise rigid structures, reinforcement structures and/or self-supporting structures, in particular recesses, openings, or the like to accommodate the functional seat structures 300, in particular seat components. The functional seat structures directly integrated into the nonwoven textile layer, in particular into a foamless nonwoven textile layer, enables a slim packaging solution for functional seat components, such as blower units and ventilation ducts, lumbar mat, massage unit, etc.

The reinforcement ribs simultaneously serve as structural stiffeners and form receiving spaces for functional seat structure components.

Each side bolster can form a respective second receiving space.

The first and second receiving spaces may be configured to at least partially accommodate a functional seat structure of the vehicle seat.

The three-dimensional shape of the textile layer, in particular a nonwoven support structure layer of the textile layer, increases its stiffness. A cushion part according to the invention with a three-dimensional nonwoven support structure layer and integrated reinforcement ribs may have a very high stiffness and yet be very comfortable. Due to the side bolsters and reinforcement ribs good comfort may be achieved even with a small foam thickness of the foam body. Compared with the prior art, it is thereby possible to achieve small thicknesses of the cushion part without the foam being too brittle or prone to tearing.

The cushion part according to the invention is a shell cushion part, in particular a shell foam part. The textile layer is, in particular, a textile shell layer.

For example, at least some of the first receiving spaces formed by the reinforcement ribs are open in a direction facing away from the foam body. The reinforcement ribs and are configured such that they provide structural support to the foam body and form open receiving spaces on the backside of the foam body for accommodating a functional seat structure.

For example, at least one of the first receiving spaces is open in a direction facing towards the foam body. The foam body can comprise a corresponding recess that is aligned with the first receiving space of the reinforcement rib to jointly form an accommodation space.

Between two adjacent reinforcement ribs a recess can be formed. The reinforcement ribs are formed such that two adjacent reinforcement ribs form a respective recess between them.

For example, a textile layer comprising a three-dimensionally shaped nonwoven support structure layer arranged on the second surface and forming a backside of the foam body, wherein the textile layer comprises a seating support surface and two side bolsters. Each of the side bolsters comprises a second receiving space, wherein at least one of the side bolsters comprises reinforcement ribs on at least one of an inner surface facing the seating support surface or an outer surface facing away from the seating support surface. Each of the reinforcement ribs forms a first receiving space.

The three-dimensional textile layer having a seating support surface which is located in an area of the seating surface of the foam body. The seating support surface is, for example, a leaning support surface. On each lateral side of the seating support surface of the textile layer, a side bolster is protruding from the seating support surface. The side bolsters bring lateral support on an A-surface for a user and lateral support on a B-surface facing away from the user. Inwardly formed sides of the reinforcement ribs, which protrude into the receiving space, may be supported on or rest on the functional seat structure, such as frame elements or wireframe elements.

In an exemplary embodiment, reinforcement ribs may be formed on the inner surface of one of the side bolsters, while the other side bolster may be configured entirely without ribs.

In an exemplary embodiment, reinforcement ribs may be formed on the inner surface of each of the side bolsters.

In an exemplary embodiment, reinforcement ribs may be formed on the outer surface of one of the side bolsters, while the other side bolster may be configured entirely without ribs.

In an exemplary embodiment, reinforcement ribs may be formed on the outer surface of each of the side bolsters.

In an exemplary embodiment, reinforcement ribs may be formed on both, the inner surface and the outer surface of one or both side bolsters.

In an exemplary embodiment, reinforcement ribs may be formed on the inner surface of one of the side bolsters and on the outer surface of the other side bolster.

An inner apex region of at least one of the side bolster and/or of one of the reinforcement ribs is configured as a bearing surface for supporting on functional seat components. That means, an inner apex region of at least one of the first receiving space and/or of one of the second receiving spaces is configured as a bearing surface for supporting on functional seat components.

Further, the first and second receiving spaces allow accommodation and protection of functional seat components of the functional seat structure, such as airbag modules and/or climate devices and/or massage control devices.

The support surface and the side bolsters are integrally formed. In other words: the textile layer is formed from a one-piece nonwoven support structure layer.

The side bolsters of the textile layer as well as the reinforcement ribs bring support and rigidity to the cushion part to accommodate and/or rest on functional seat components. The textile layer may be placed on and connected to a functional seat structure.

Due to the textile layer a foam thickness on the A-surface and/or a foam thickness on the B-surface may be decreased. The cushion part has a slim appearance and a rear side of the cushion part may be provided with an increased leg and knee room. The B surface is adapted for integration of additional functional seat components, said components being at least partially enclosed by, held by and/or attached to the textile layer.

By providing side bolsters a foam volume may be reduced as an alternative to replace an in-molded wireframe.

The reinforcement ribs are bulges, for example trapezoidal bulges. Said bulges being configured to contact and/or rest on a metal seat structure in an assembled state to provide lateral support and rigidity.

The second receiving space of each side bolster allows simple functional seat component integration. By holding or assembling functional seat components, such as comfort seat components, on the B-surface, such components may be integrated in small foam thickness environments.

The textile layer may comprise a number of fastening elements arranged within the second receiving space of at least one of the side bolsters. The fastening elements may be formed integrally with the nonwoven support structure layer during shaping of the textile layer.

Each of the side bolsters may comprise two legs that together enclose the second receiving space. The side bolsters may comprise a U-shape or V-shape configuration.

At least one of the legs of at least one of the side bolsters may comprise the reinforcement ribs. Each leg of the side bolsters defines either the inner surface or the outer surface of the respective side bolster. Each reinforcement rib may have a U-shaped configuration.

The cushion part may comprise side bolsters and/or reinforcement ribs having a U-shaped or multi-bent configuration that defines respective receiving spaces or openings on the B-surface.

In cross-section of the side bolster, the side bolster and the reinforcement ribs, respectively the first receiving spaces and the second receiving spaces, may differ in heights.

In longitudinal section of the side bolster, at least one of the legs of at least one of the side bolsters comprises a meandering structure. This provides improved support for the foam material of the foam body, enhances bonding between the foam material and the nonwoven support structure layer, and enables additional fixation of the foam material and the nonwoven support structure layer in an area of recesses, grooves or indentations, and ridges or raised portions of the meandering structure.

The seating support surface can comprise a meandering structure, in particular in cross-section, extending in a transverse direction and/or vertical direction of the seating support surface. Said meandering structure can comprise alternating reinforcement ribs and recesses.

For example, at least one of the reinforcement ribs is U-shaped in cross-section and comprises a ventilation hole formed in a web region of the U-shape. Said ventilation hole provides fluid communication between the first receiving space of said reinforcement rib and the foam body and/or a ventilation device.

For example, each or some of the reinforcement ribs may form an air-guiding channel along its extension.

The reinforcement ribs may have identical dimensions. The reinforcement ribs may have different dimensions in at least one of their length, height, width or thickness. The reinforcement ribs may be acute-angled. The number and shape of the reinforcement ribs may vary depending on the expected sensation of stiffness, the seat structure of the vehicle seat and the customer's wishes.

The reinforcement ribs are arranged substantially in parallel with one another along an extension direction of the side bolsters.

For example, the cushion part is a backrest cushion part. The extension direction of the side bolsters may refer to a vertical extension direction of the backrest.

For example, the cushion part is a seat cushion part. The extension direction of the side bolsters may refer to a longitudinal extension direction of a seat part.

The reinforcement ribs may be formed integrally with the nonwoven support structure layer during shaping of the textile layer.

The nonwoven support structure layer may have a grammage between 450 to 1200 grams per square meter. The fact that the nonwoven support structure layer has a grammage between 450 to 1200 grams per square meter provides the possibility of making the cushion part a load-bearing part.

The nonwoven support structure layer may be thermoformed. The nonwoven support structure layer may be overmolded with foam. The nonwoven support structure layer may be partially penetrated by foam material of the foam body. The nonwoven support structure layer may be completely penetrated by foam material of the foam body.

The foam body may have a thickness of less than or equal to 30 millimeters at least in the region of the support surface and/or the side bolsters.

The foam body may be made from polyurethane foam.

The nonwoven support structure layer may comprise polyester fibers and/or polypropylene fibers. The nonwoven support structure layer may have a layer thickness from 0.5 millimeters to 7 millimeters.

The nonwoven support structure layer may have a modulus of elasticity of from 300 megapascals to 1000 megapascals.

A tensile strength of the nonwoven support structure layer may reach from 8 megapascals to 20 megapascals. The high tensile strength of the nonwoven support structure layer makes it possible to attach external components made of plastic or composite material or metal. Further functions and components of the vehicle seat may be integrated into the nonwoven support structure layer, for example spacers, under-cushioning mat fixings, massage mats, cable snap-in connections, trim channels and/or ventilation fixings. In the case of cushion parts known from the prior art, direct fastening of external components is not possible owing to the risk that they will be torn out.

The pull-out force of the nonwoven support structure layer may be greater than 200 newtons. The nonwoven support structure layer may have a Poisson number of from 0.3 to 0.5. The elongation at break of the nonwoven support structure layer may be 30 percent to 40 percent. The Shore hardness may be greater than 50 Shore A.

A method for producing a cushion part according to the invention, may comprise at least the following method steps:
thermoforming a textile layer into a three-dimensionally shaped nonwoven support structure layer,
inserting the three-dimensionally shaped nonwoven support structure layer into a foaming tool, wherein the three-dimensionally shaped nonwoven support structure layer has at least one previously described feature,
feeding a foamable material into the foaming tool, and
removing the cushion part from the foaming tool.

Forming, in particular thermoforming, may be accomplished by a deep-drawing process.

The object is also achieved according to the invention by a vehicle seat having at least one cushion part according to the invention. The vehicle seat may have a seating part. The vehicle seat may have a backrest. The backrests may be secured on the seating part. The backrests may be secured on the seating part in a pivotable manner, in particular by at least one fitting.

The fact that the vehicle seat has a cushion part according to the invention enables functional systems of the vehicle seat to be integrated in the side bolsters for slim appearance. Further, the textile layer has a sufficiently high stiffness to secure functional systems on the textile layer.

The seating part may have at least one load-bearing functional seat structure, which carries at least one cushion part according to the invention or supports a section or sections thereof. The backrest may have at least one load-bearing functional seat structure, which carries at least one cushion part according to the invention or supports a section or sections thereof.

The functional seat structure is at least partially arranged within at least one of the first or second receiving spaces, and comprises at least one of a functional seat component, such as a frame component, an airbag module, a massage device, a ventilation device or a heating device or any other comfort seat part.

In an assembled state of the functional seat structure and the cushion part, an inner apex region of the first receiving space and/or the second receiving space is in contact with the functional seat structure and/or supported thereon.

In summary, and in other words, the invention provides a highly rigid and thin foam cushion by overmolding a highly rigid, thermoformed nonwoven with foam. The nonwoven composition typically contains polyester fibers. It may also contain polypropylene.

The use of a highly rigid thermoformed nonwoven is preferred. The highly rigid nonwoven may be overmolded with polyurethane foam. The foam may or may not penetrate into the nonwoven. The stiffness of thermoformed nonwoven may be adjusted by varying parameters of the deep-drawing process, the geometry of the nonwoven or the nonwoven material. The nonwoven material may be a nonwoven polyester or some other polymer. The nonwoven material may contain additives which may change the mechanical properties of the thermoformed nonwoven.

Further scope of applicability of the present invention will become apparent from the detailed description given hereinafter. However, it should be understood that the detailed description and specific examples, while indicating preferred exemplary embodiments of the invention, are given by way of illustration only, since various changes and modifications within the spirit and scope of the invention will become apparent to those skilled in the art from this detailed description.

### DESCRIPTION OF THE FIGURES

The present invention will become more fully understood from the detailed description given herein below and the accompanying drawings which are given by way of illustration only, and thus, are not limitative of the present invention, and wherein:

FIG. 1 a vehicle seat comprising at least a seat part and a backrest, the seat part and/or the backrest comprising a cushion part, the cushion part is made from a foam body and a textile layer,

FIG. 2 a perspective view of a first exemplary embodiment of a textile layer for a cushion part of a vehicle seat, the textile layer comprising a three-dimensionally shaped nonwoven support structure layer,

FIG. 3 another perspective view of the textile layer according to FIG. 2,

FIG. 4 a sectional view of the textile layer bonded to a foam body through the section line IV-IV according to FIG. 2,

FIG. 5 a sectional view of the textile layer bonded to a foam body through the section line V-V according to FIG. 2,

FIG. 6 a sectional view of the textile layer bonded to a foam body through the section line VI-VI according to FIG. 2,

FIG. 7 a perspective view of a second exemplary embodiment of a textile layer for a cushion part of a vehicle seat, the textile layer comprising a three-dimensionally shaped nonwoven support structure layer,

FIG. 8 a perspective view of a first exemplary embodiment of a cushion part comprising the textile layer according to FIG. 7 and a foam body which is bonded to the textile layer,

FIG. 9 a sectional view of the cushion part through the section line IX-IX according to FIG. 8,

FIG. 10 a sectional view of the cushion part through the section line X-X according to FIG. 7,

FIG. 11 a sectional view of the cushion part through the section line XI-XI according to FIG. 7,

FIG. 12 a perspective view of a third exemplary embodiment of a textile layer for a cushion part of a vehicle seat, the textile layer comprising a three-dimensionally shaped nonwoven support structure layer,

FIG. 13 a perspective view of a second exemplary embodiment of a cushion part comprising the textile layer according to FIG. 12 and a foam body which is bonded to the textile layer,

FIG. 14 a sectional view of the cushion part through the section line XIV-XIV according to FIG. 13,

FIG. 15 a sectional view of a third embodiment of a cushion part comprising a foam body and a textile layer,

FIG. 16 an exploded view of the cushion part according to FIG. 15,

FIG. 17 a sectional view of a fourth embodiment of a cushion part comprising a foam body and a textile layer,

FIG. 18 an exploded view of the cushion part according to FIG. 17, and

FIG. 19 a sectional view of a fifth embodiment of a cushion part comprising a foam body and a textile layer.

### DETAILED DESCRIPTION

Corresponding parts are marked with the same reference symbols in all figures.

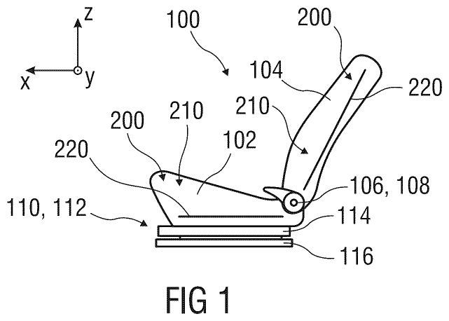

FIG. 1 shows a vehicle seat 100 comprising at least a seat part 102 and a backrest 104, the seat part 102 and/or the backrest 104 comprising a cushion part 200 according to the invention, the cushion part 200 is made from a foam body 210 and a textile layer 220.

The vehicle seat 100 will be described below with reference to three spatial directions that are perpendicular to one another. A longitudinal direction x extends substantially horizontally when the vehicle seat 100 is installed in a vehicle, and preferably parallel to a vehicle longitudinal axis that corresponds to the usual driving direction of the vehicle. A transverse direction y, which extends perpendicular to the longitudinal direction x, is likewise oriented horizontally in the vehicle and runs parallel to a vehicle transverse axis. A vertical direction z extends perpendicular to the longitudinal direction x and perpendicular to the transverse direction y. When the vehicle seat 100 is installed in the vehicle, the vertical direction z preferably extends parallel to a vehicle vertical axis.

The positional and directional indications used, such as front, rear, top, and bottom, refer to the viewing direction of an occupant I seated in the vehicle seat 100 in a normal seating position, wherein the vehicle seat 100 is installed in the vehicle in a use position suitable for transporting persons, with a seat backrest 104 in an upright position and, as usual, oriented in the driving direction. However, the vehicle seat 100 may also be installed or moved in a different orientation, for example transverse to the driving direction. Unless described otherwise, the vehicle seat 100 is of mirror-symmetrical configuration relative to a plane that extends perpendicular to the transverse direction y.

The backrest 104 may be pivotably arranged on a seat part 102 of the vehicle seat 100. For this purpose, the vehicle seat 100 may optionally comprise a fitting 106, in particular an adjustment fitting, rotary fitting, latching fitting, or tilt fitting.

The positional and directional indications used, such as radial, axial, and circumferential, refer to a rotational axis 108 of the fitting 106. Radial means perpendicular to the rotational axis 108. Axial means in the direction of or parallel to the rotational axis 108.

The vehicle seat 100 may optionally comprise a longitudinal adjustment device 110. The longitudinal adjustment device 110 comprises, for example, a rail arrangement 112 having a first rail element 114 and a second rail element 116. The first rail element 114 is adjustable relative to the second rail element 116 in the longitudinal direction x. The first rail element 114 is fastened to the seat part 102. The first rail element 114 is, for example, an upper rail or a slide rail. The second rail element 116 is fastened to a structural component of a vehicle, for example a vehicle floor. The second rail element 116 is, for example, a lower rail or floor rail.

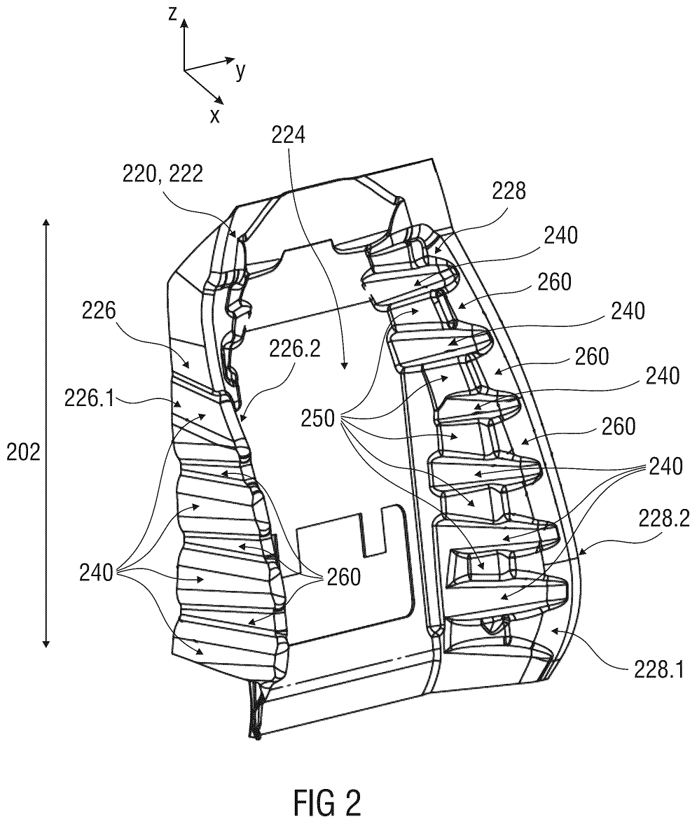

FIG. 2 shows a perspective view of a first exemplary embodiment of a textile layer 220 for a cushion part 200 of a vehicle seat 100. The textile layer 220 may comprise a three-dimensionally shaped nonwoven support structure layer 222. The textile layer 220 may be a three-dimensionally shaped shell fleece. The cushion part 200 is designed as a backrest cushion. Analogously, but not further shown, a seat cushion for a seat part 102 can be configured in the same manner as described below.

The textile layer 220 is hereinafter referred to as the nonwoven textile layer 220. However, the textile layer 220 may, alternatively or additionally, comprise a different three-dimensionally shaped support structure layer 222, for example a knitted, woven or spacer fabric layer.

The nonwoven textile layer 220 is configured to be overmolded, for example back-foamed, by a foam material.

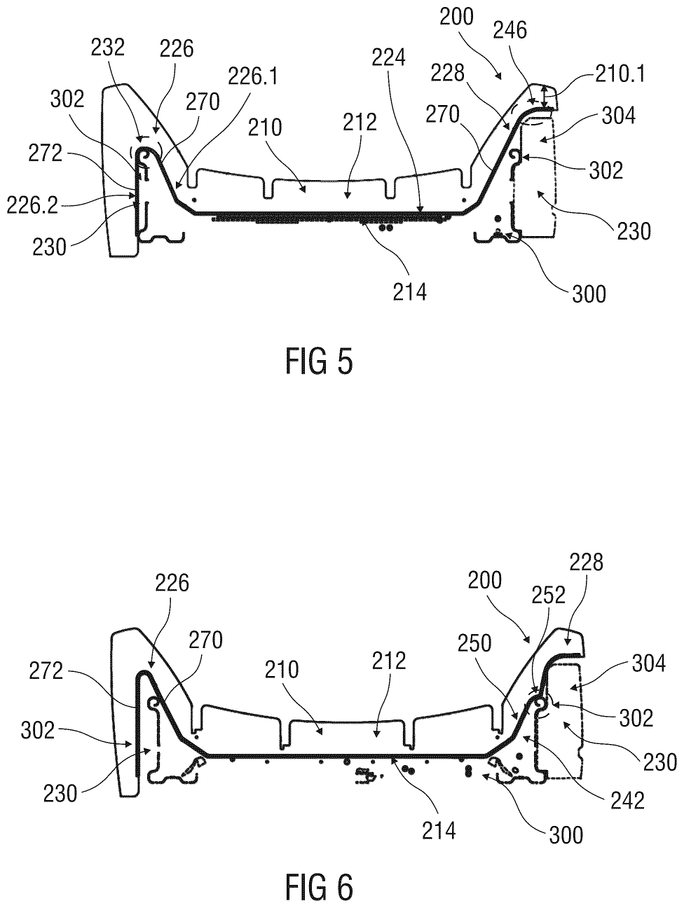

The nonwoven textile layer 220 comprises a seating support surface 224, such as a sitting surface or leaning surface, and two side bolsters 226, 228. Each of the side bolsters 226, 228 comprises a second receiving space 230 (shown in FIGS. 5 and 6), for example, a receiving opening, depression, or the like.

At least one of the side bolsters 226, 228 comprises reinforcement ribs 240 on at least one of an inner surface 226.1, 228.1 facing the seating support surface 224 or an outer surface 226.2, 228.2 facing away from the seating support surface 224. According to the shown embodiment, one of the side bolsters 226 comprises reinforcements ribs 240 on both, the inner surface 226.1 and the outer surface 226.2. The other side bolster 228 comprises reinforcement ribs 240 on at least the inner surface 228.1.

In an exemplary embodiment, reinforcement ribs 240 may be formed on the inner surface 226.1, 228.1 of one of the side bolsters 226, 228, while the other side bolster 226, 228 may be configured entirely without ribs 240.

In an exemplary embodiment, reinforcement ribs 240 may be formed on the inner surface 226.1, 228.1 of each of the side bolsters 226, 228.

In an exemplary embodiment, reinforcement ribs 240 may be formed on the outer surface 226.2, 228.2 of one of the side bolsters 226, 228, while the other side bolster 226, 228 may be configured entirely without ribs 240.

In an exemplary embodiment, reinforcement ribs 240 may be formed on the outer surface 226.2, 228.2 of each of the side bolsters 226, 228.

In an exemplary embodiment, reinforcement ribs 240 may be formed on both, the inner surface 226.1, 228.1 and the outer surface 226.2, 228.2 of one or both side bolsters 226, 228.

In an exemplary embodiment, reinforcement ribs 240 may be formed on the inner surface 226.1, 228.1 of one of the side bolsters 226, 228 and on the outer surface 226.2, 228.2 of the other side bolsters 226, 228.

The reinforcement ribs 240 on each of the surfaces 226.1 to 228.2 can have identical dimensions. The reinforcement ribs 240 have different dimensions in at least one of their length, height, width or thickness.

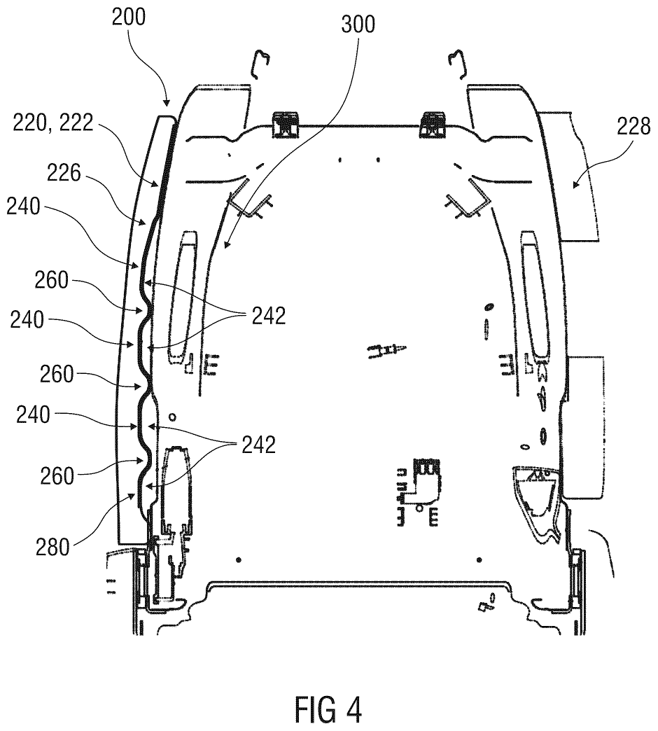

Each of the reinforcement ribs 240 forms a first receiving space 242 (shown in FIGS. 4 to 6).

The first and second receiving spaces 230, 242 may be configured to at least partially accommodate a functional seat structure 300 (shown in FIGS. 5 and 6) of the vehicle seat 100.

The reinforcement ribs 240 may be configured as bulges or protrusions which protrude from a plane of a respective surface 226.1 to 228.2 and which have cavities formed on the other side of the surface 226.1 to 228.2. The first and second receiving spaces 230, 242 are configured as cavities, grooves, or the like.

The reinforcement ribs 240 may be configured as three-dimensional shaped protrusions, for example with trapezoidal shaped cross-section. The respective surface 226.1 to 228.2 comprises indentations, curvatures or bulges between adjacent ribs 240.

The side bolster 226, 228 tapers towards its upper end in a shoulder region and has a greater width or cross-sectional extension at its lower end in a hip or back region. The side bolster 226, 228 protrudes forward from the seating, for example leaning, support surface 224 and defines a second receiving space 230 that is open towards a rear side of the backrest 104.

The respective side bolster 226, 228 comprises, on at least one of its inner surfaces 226.1, 228.1 and/or outer surfaces 226.2, 228.2, reinforcement ribs 240 at least in sections of the respective side bolster 226, 228.

The reinforcement ribs 240 can be formed along an extension direction 202, for example along a vertical extension direction 202, of the respective side bolster 226, 228 by alternating projections and recesses 260 on the respective surface 226.1 to 228.2.

The reinforcement ribs 240 are formed integrally with the nonwoven textile layer 220 during shaping, for example thermoforming, of the nonwoven textile layer 220, in particular of the nonwoven support structure layer 220.

Furthermore, at least one of the side bolsters 226, 228, in particular at least one of the surfaces 226.1 to 228.2, comprises a stepped portion 250. The reinforcement ribs 240 can be formed as three-dimensional protrusions that are interconnected by the stepped portions 250. The reinforcement ribs 240 and the stepped portions 250 form an alternating pattern of projections and recesses 260 along the respective surface 226.1 to 228.2 of the side bolster 226, 228. The reinforcement ribs 240 can protrude beyond a basic contour of the stepped portions 250. The stepped portions 250 are configured to connect adjacent reinforcement ribs 240 in a staggered manner.

The stepped portions 250 are formed integrally with the nonwoven textile layer 220 during shaping, for example thermoforming, of the nonwoven textile layer 220.

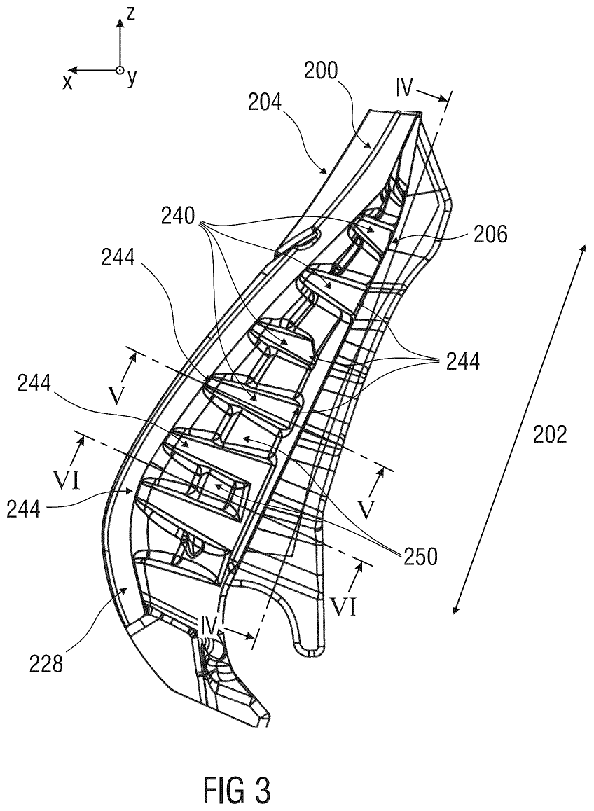

FIG. 3 shows another perspective view of the textile layer 220 according to FIG. 2.

The reinforcement ribs 240 are arranged substantially in parallel with one another along the extension direction 202 of the side bolsters 226, 228.

Furthermore, axial ends 244 of at least some of the reinforcement ribs 240 can be aligned with one another at least with respect to a front-facing side 204 and/or a rear-facing side 206 of the cushion part 200 along the extension direction 202 of the side bolsters 226, 228.

Axial ends 244 of at least some of the reinforcement ribs 240 can be located offset or flush with respect to one another.

For example, in the case of a seat part 102, axial ends 244 of at least some of the ribs 240 can be aligned with one another at least on an upper-facing side and/or a lower-facing side, along a seat part extension direction of the seat part 102.

The reinforcement ribs 240 can have identical dimensions. In the shown embodiment, the reinforcement ribs 240 have different dimensions in at least one of their length, height, width or thickness.

The reinforcement ribs 240 can have identical shapes, for example trapezoidal shapes. The reinforcement ribs 240 can have different three-dimensional shapes.

The side bolster 226, 228 narrows towards its upper end (shoulder region) and widens towards its lower end (back or hip region).

For example, the ribs 240 may be shorter in an upper backrest region than in a lower backrest region.

FIG. 4 shows a sectional view of the nonwoven textile layer 220 bonded to a foam body 210 through the section line IV-IV according to FIG. 2.

Each of the reinforcement ribs 240 forms a first receiving space 242 (shown in FIGS. 4 and 6).

The first and second receiving spaces 230, 242 may be configured to at least partially accommodate a functional seat structure 300 (shown in FIGS. 5 and 6) of the vehicle seat 100.

The reinforcement ribs 240 may be configured as bulges or protrusions which protrude from a plane of a respective surface 226.1 to 228.2 and which have cavities formed on the other side of the surface 226.1 to 228.2. The first and second receiving spaces 230, 242 are configured as cavities, grooves, or the like.

The reinforcement ribs 240 may be configured as three-dimensional shaped protrusions, for example with trapezoidal shaped cross-section. The respective surface 226.1 to 228.2 comprises indentations, curvatures or bulges between adjacent ribs 240.

In longitudinal section of the side bolster 226, 228, at least one of the inner or outer surfaces 226.1, 228.2 comprises a meandering structure 280. The meandering structure 280 is formed by alternating protruding ribs 240 and recesses 260 between adjacent ribs 240. This provides improved support for the foam material of the foam body 210, enhances bonding between the foam material and the nonwoven support structure layer 222, and enables additional fixation of the foam material of the foam body 210 and the nonwoven support structure layer 222 in an area of the recesses 260 and ribs 240 of the meandering structure 280.

FIG. 5 shows a sectional view of the nonwoven textile layer 220 bonded to a foam body 210 through the section line V-V according to FIG. 2.

The receiving spaces 230, 242 are configured as cavities that are open at a rear side of the cushion part 200, while the side bolsters 226, 228 project forward from the seating support surface 224.

The foam body 210 comprises a first surface 212 forming a seating surface and an opposite second surface 214, for example a bonding surface to be bonded to the nonwoven textile layer 220. The foam body 210 is formed at least partially surrounding the side bolsters 226, 228 of the nonwoven textile layer 220.

In the shown embodiment, the left side bolster 226 comprise two legs 270, 272 that together enclose the second receiving space 230. The right side bolster 228 comprises one bent leg 270 defining a partially open second receiving space 230. A first leg 270 defines the inner surface 226.1, 228.1. A second leg 272 defines the outer surface 226.2, 282.2.

The functional seat structure 300 is at least partially arranged within at least one of the first or second receiving spaces 230, 242. The functional seat structure 300 comprises at least one of a frame component 302, an airbag module 304, a massage device, a ventilation device or a heating device.

In an assembled state of the functional seat structure 300 and the cushion part 200, an inner apex region 232, 246 of the second receiving space 230 and/or the first receiving space 242 is in contact with the functional seat structure 300 and/or supported thereon.

For example, the inner apex region 232 of the side bolster 226, that means of the second receiving space 230, is supported on the frame component 302. Due to the tapering shape of the side bolster 226, the inner apex region 232 of the side bolster 226 in an upper or shoulder region may be in contact and supported on the frame component 302, while an inner apex region 232 of the side bolster 226 in a lower or hip region may be out of contact and distanced from the frame component 302, as shown in FIG. 6.

The foam body 210 has a thickness 210.1 of less than or equal to 30 millimeters at least in the region of the support surface 224 and/or the side bolsters 226, 228 of the nonwoven textile layer 220.

FIG. 6 shows a sectional view of the nonwoven textile layer 220 bonded to a foam body 210 through the section line VI-VI according to FIG. 2.

The embodiment shows an inner apex region 252 of the stepped portion 250 supported on the frame component 302.

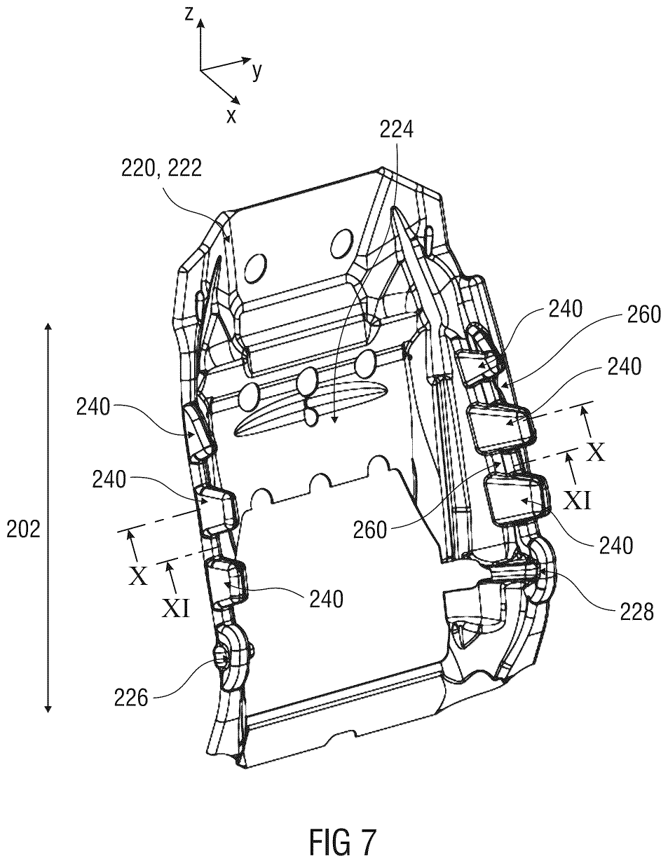

FIG. 7 shows a perspective view of a second exemplary embodiment of a nonwoven textile layer 220 for a cushion part 200 of a vehicle seat 100, the textile layer 220 comprising a three-dimensionally shaped nonwoven support structure layer 222. The nonwoven textile layer 220 is configured analogously to the previously described configuration, except that the positions, number and/or shapes of the reinforcement ribs 240 has been modified.

Each of the side bolsters 226, 228 of the nonwoven textile layer 220 comprises reinforcement ribs 240, for example three ribs 240, on the respective inner surface 226.1, 228.1. The side bolsters 226, 228 comprises recesses 260 which separate adjacent ribs 240. The ribs 240 extend over a basic contour of the side bolsters 226, 228. In cross-section of the side bolsters 226, 228, the side bolsters 226, 228 and the reinforcement ribs 240 differ in heights.

The reinforcement ribs 240 may be configured as three-dimensional shaped protrusions, for example with trapezoidal shaped cross-section.

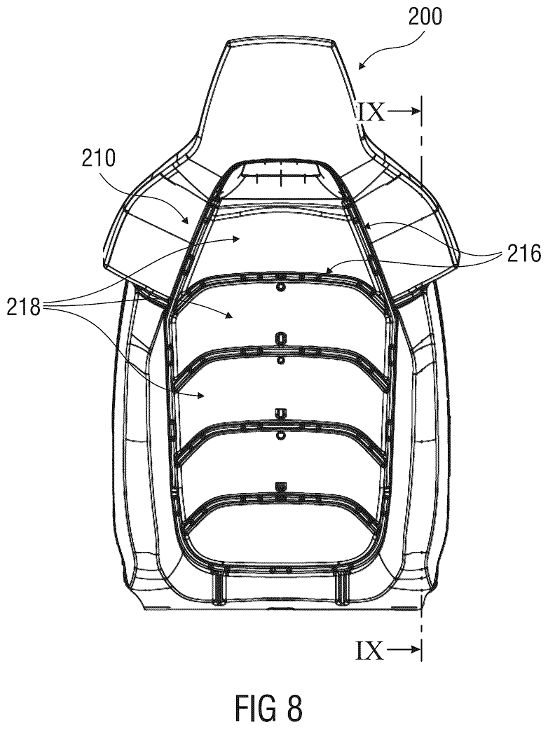

FIG. 8 shows a perspective view of a first exemplary embodiment of a cushion part 200 comprising the nonwoven textile layer 220 according to FIG. 7 and a foam body 210 which is bonded to the nonwoven textile layer 220.

The foam body 210 comprises a number of ventilation channels 216 and a number of comfort tubes and/or comfort sections 218. The foam body 210 is formed completely surrounding the side bolsters 226, 228 of the nonwoven textile layer 220.

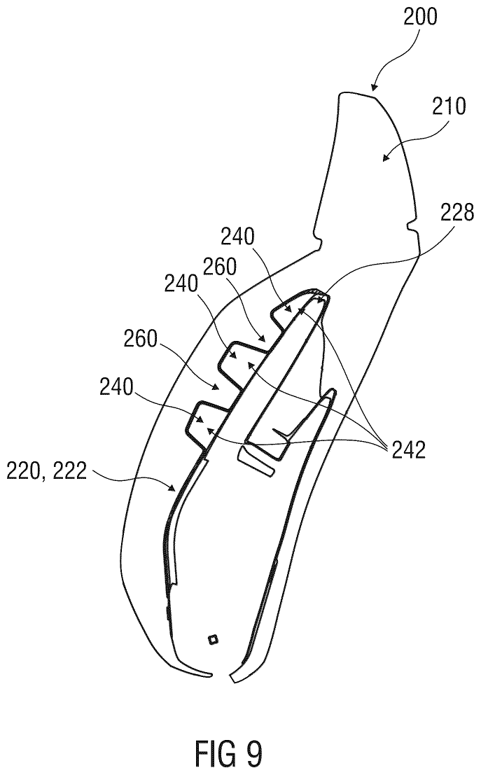

Additionally or optionally, the nonwoven textile layer 220 can comprise ventilation channels 216, wherein the ventilation channels 216 are formed by respective recesses 260 between adjacent reinforcement ribs 240 (for example shown in FIG. 9).

FIG. 9 shows a sectional view of the cushion part 200 through the section line IX-IX according to FIG. 8. Each of the reinforcement ribs 240 forms a first receiving space 242.

The side bolsters 226, 228 comprise alternating sections along their extension direction 202, with recesses 260 and ribs 240. In cross-section, the contour of the side bolsters 226, 228 is configured crown-shaped or tooth-shaped. The side bolsters 226, 228 of the nonwoven textile layer 220 are embedded in the foam body 210.

The recesses 260 and ribs 240 alternate in the vertical direction z and vary in their heights.

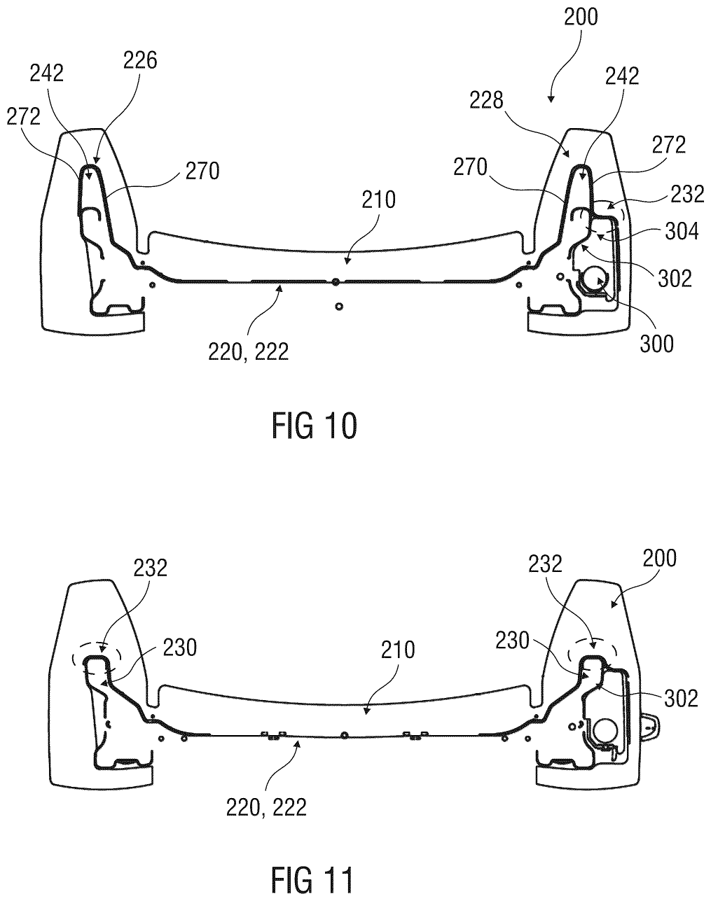

FIG. 10 shows a sectional view of the cushion part 200 through the section line X-X according to FIG. 7.

Each side bolster 226, 228 comprises an inner leg 270 and an outer leg 272, wherein the inner leg 270 or the outer leg 272 is shorter in length than the other leg 270, 272.

A free end of the outer leg 272 may be bent inwardly towards the inner leg 270 and may include a substantially horizontal portion forming an inner apex region 232 of the second receiving space 230 enclosed by the respective legs 270, 272. The foam body 210 at least partially surrounds the outer leg 270 and its horizontal portion. The inner apex region 232 of the outer leg 270 is rested on a part of the functional seat structure 300. The reinforcement ribs 240 extends over the horizontal portion, or inner apex region 232, and forms a rigid lateral support for a user.

FIG. 11 shows a sectional view of the cushion part 200 through the section line XI-XI according to FIG. 7.

The inner apex regions 232 of the side bolsters 226, 228 are supported on parts of the functional seat structure 300. Each inner apex region 232 of the side bolsters 226, 228 is formed in a connection region of the legs 270, 272.

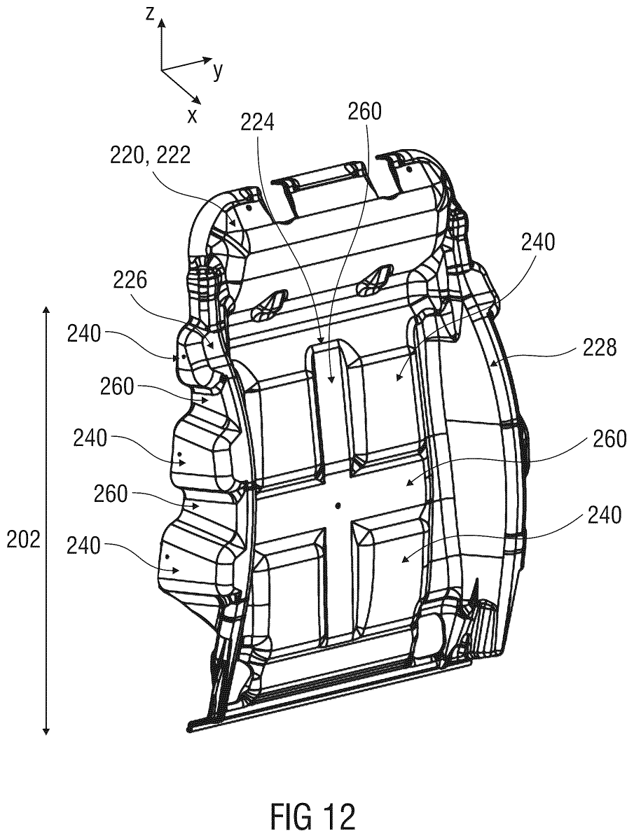

FIG. 12 shows perspective view of a third exemplary embodiment of a nonwoven textile layer 220 for a cushion part 200 of a vehicle seat 100, the nonwoven textile layer 220 comprising a three-dimensionally shaped nonwoven support structure layer 222. The nonwoven textile layer 220 is configured analogously to the previously described configuration, except that the positions, number and/or shapes of the reinforcement ribs 240 has been modified.

Each of the side bolsters 226, 228 of the nonwoven textile layer 220 comprises reinforcement ribs 240 on the respective outer surface 226.2, 228.2. The side bolsters 226, 228 comprises recesses 260 which separate adjacent ribs 240. The ribs 240 extend over a basic contour of the side bolsters 226, 228. In cross-section of the side bolsters 226, 228, the side bolsters 226, 228 and the reinforcement ribs 240 are identical in heights.

The reinforcement ribs 240 may be configured as three-dimensional shaped protrusions, for example with trapezoidal shaped cross-section.

Moreover, the seating support surface 224 of the nonwoven textile layer 220 comprises reinforcement ribs 240. The seating support surface 224 comprises a T-shaped, cross-shaped or X-shaped recess 260 in a center region of the seating support surface 224. The recess 260 is shaped between adjacent reinforcement ribs 240 on the seating support surface 224.

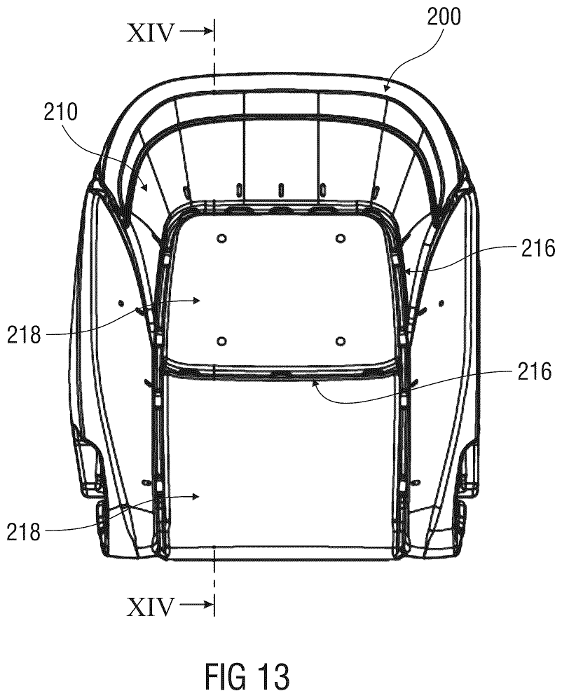

FIG. 13 shows perspective view of a second exemplary embodiment of a cushion part 200 comprising the nonwoven textile layer 220 according to FIG. 12 and a foam body 210 which is bonded to the nonwoven textile layer 220.

The foam body 210 comprises a number of ventilation channels 216 and a number of comfort tubes and/or comfort sections 218. The foam body 210 is formed partially or completely surrounding the side bolsters 226, 228 of the nonwoven textile layer 220.

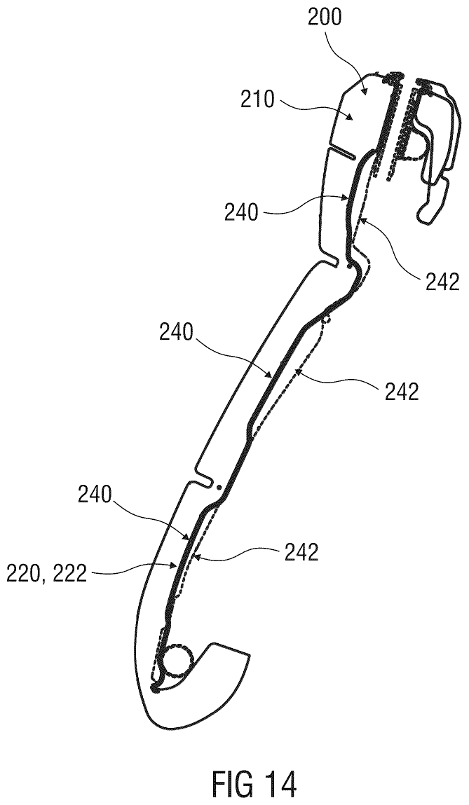

FIG. 14 shows a sectional view of the cushion part 200 through the section line XIV-XIV according to FIG. 13.

The nonwoven textile layer 220 comprises a three-dimensionally shaped nonwoven support structure layer 222. The nonwoven textile layer 220 having a grammage between 450 to 1200 grams per square meter.

Each reinforcement rib 240 on the seating support surface 224 of the nonwoven textile layer 220 defines a respective first receiving space 242. This design enables a reduced B-surface, providing additional legroom.

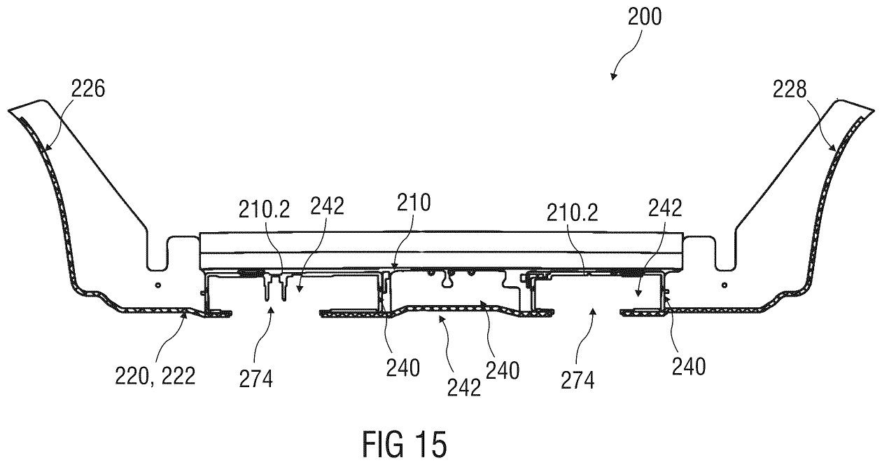

FIG. 15 shows a sectional view of a third embodiment of a cushion part 200 comprising a foam body 210 and a textile layer 220. The textile layer 220 may be a three-dimensionally shaped shell fleece. The cushion part 200 is designed as a backrest cushion. Analogously, but not further shown, a seat cushion for a seat part 102 can be configured in the same manner as described below.

The nonwoven textile layer 220 comprises a seating support surface 224, such as a sitting surface or leaning surface, and two side bolsters 226, 228.

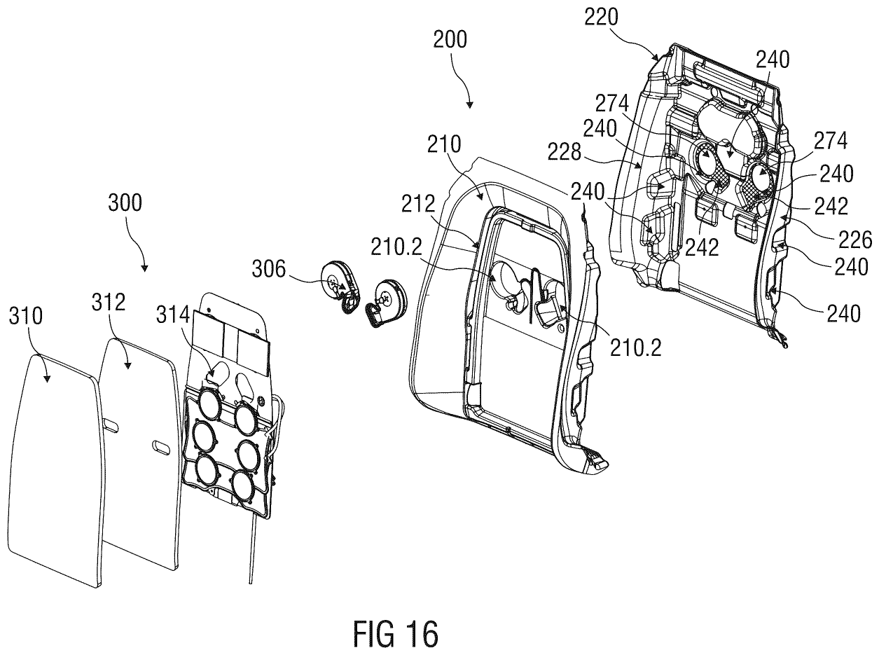

In particular, the functional seat components and/or functional seat structures 300, e.g. components, such as blower units 306 and/or ventilation device 306 (shown in FIG. 16), may be integrated or attached directly to the nonwoven textile layer 220, e.g. a 3D-shaped textile layer without foam or foam body 210. The 3D-shaped textile layer 220, e.g. a shell fleece, may comprise rigid structures, reinforcement structures and/or self-supporting structures, in particular recesses, openings, or the like to accommodate the functional seat structures 300, in particular seat components. The functional seat structures 300 directly integrated into the nonwoven textile layer 220, in particular into a foamless nonwoven textile layer 220, enables a slim packaging solution for functional seat components, such as blower units and ventilation ducts, lumbar mat, massage unit, etc.

The seating support surface 224 comprises a number of reinforcement ribs 240. In the shown embodiment, the seating support surface 224 comprises at least three reinforcement ribs 240. Slimmer seat profiles can be achieved by eliminating foam support beneath components such as ventilation devices 306 (shown in FIG. 16), such as blowers, electric motors, ECU, exciters, etc. The nonwoven textile layer 220, in particular a shell fleece, is self-supporting and offers superior rigidity compared to standard densification typically achieved through a combination of conventional fleece and foam over-foaming. When styling modifications are not feasible. By means of the shown nonwoven textile layer 220 and its integrated reinforcement ribs 240 a blower's position and size can be optimized to enable integration within a thinner seat package. Such assembly concept can avoid threaded fasteners and/or adhesive bonding which need additional fixtures and assembly time.

At least two of the reinforcement ribs 240 comprises first receiving spaces 242 which are open in a direction facing towards the foam body 210. At least one of the reinforcement ribs 240 comprises a first receiving space 242 which is open in a direction facing away from the foam body 210.

The foam body 210 comprises corresponding foam body recesses 210.2 which, in an assembled state of the cushion part 200, are aligned with the first receiving spaces 242 which are open towards the foam body 210 to jointly form an accommodation space. Corresponding reinforcement ribs 240 can have at least similar or identical shapes as the foam body recesses 210.2. The reinforcement ribs 240 comprises ventilation holes 274, in particular through holes from A-surface to B-surface, providing space for electrical connections for the ventilation devices 306.

FIG. 16 shows an exploded view of the cushion part 200 according to FIG. 15.

The cushion part 200 comprises further a comfort pad 310, a spacer 312 and a mat 314. The mat 314 can comprise lumbar support components and massage cells.

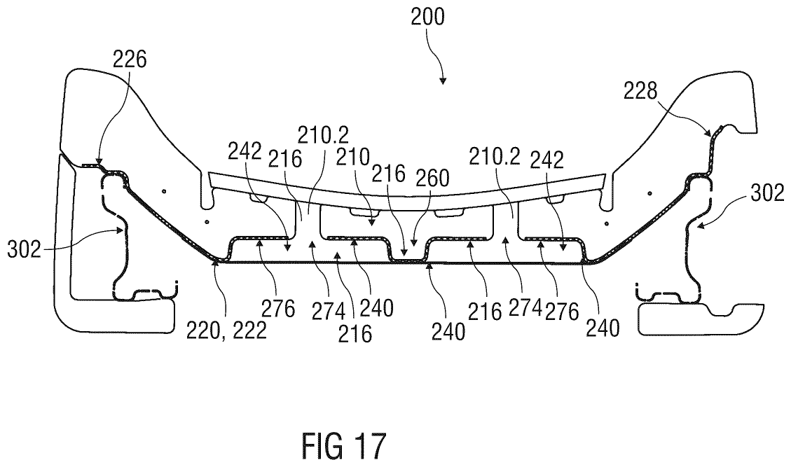

FIG. 17 shows a sectional view of a fourth embodiment of a cushion part 200 comprising a foam body 210 and a textile layer 220. The textile layer 220 may be a three-dimensionally shaped shell fleece. The cushion part 200 is designed as a backrest cushion. Analogously, but not further shown, a seat cushion for a seat part 102 can be configured in the same manner as described below.

The nonwoven textile layer 220 comprises a seating support surface 224, such as a sitting surface or leaning surface, and two side bolsters 226, 228.

Additionally or optionally, the nonwoven textile layer 220 can comprise at least one ventilation channel 216. The ventilation channel 216 may be configured as reinforcing air ventilation channel 216. The ventilation channels 216 may be formed by respective recesses 260 within the nonwoven textile layer 220, e.g. between adjacent reinforcement ribs 240.

The seating support surface 224 comprises a plurality of reinforcement ribs 240.

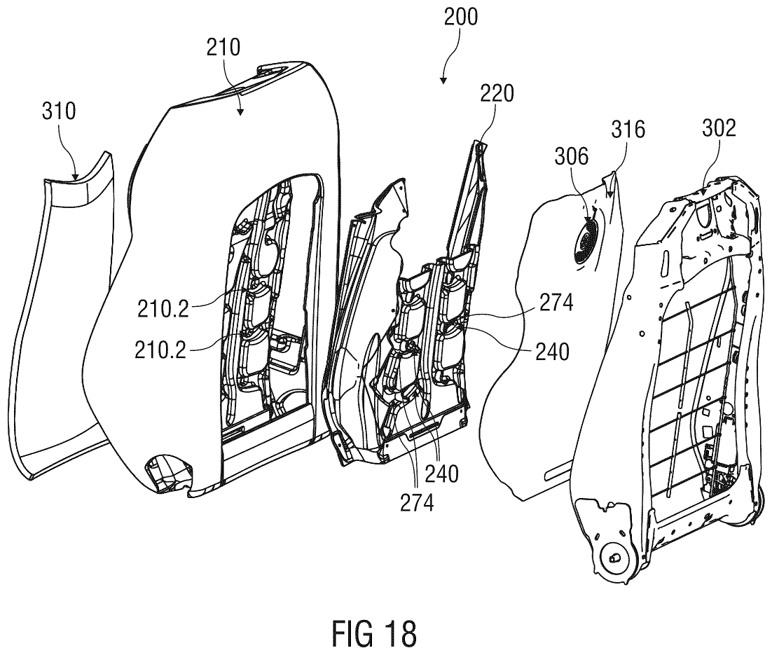

The reinforcement ribs 240 are formed on the seating support surface 224 of the nonwoven textile layer 220 extending in a transverse direction y. As shown in FIG. 18, the reinforcement ribs 240 also extend in a vertical direction z. A recess 260 is formed between two adjacent reinforcement ribs 240. The reinforcement ribs 240 comprises first receiving spaces 242 which are open in a direction facing away from the foam body 210. Further, each of the reinforcement ribs 240 can be substantially U-shaped and comprise a ventilation hole 274 formed in a web region 276 of the U-shape.

The foam body 210 comprises corresponding foam body recesses 210.2 which, in an assembled state of the cushion part 200, are aligned with the ventilation holes 274 of said reinforcement ribs 240. Thereby, fluid communication between the first receiving spaces 242 of said reinforcement ribs 240 and the foam body 210 can be provided. The foam body 210 structurally supports the seat B-surface, avoiding deformation under occupant load while maintaining geometry of integrated air channels within the nonwoven textile layer 220. The nonwoven textile layer 220 provides homogeneous pressure distribution as it avoids hard point contact of occupant with the ventilation device 306, in particular the blower.

A frame component 302 extends along the side bolsters 226, 228 of the nonwoven textile layer 220. The nonwoven textile layer 220 is supported on the frame component 302 in the region of the side bolsters 226, 228.

FIG. 18 shows an exploded view of the cushion part 200 according to FIG. 17.

The cushion part 200 further comprises a comfort pad 310 and a sealing fleece 316 with a ventilation device 306. The sealing fleece 316 is arranged between the frame components 302 and the nonwoven textile layer 220.

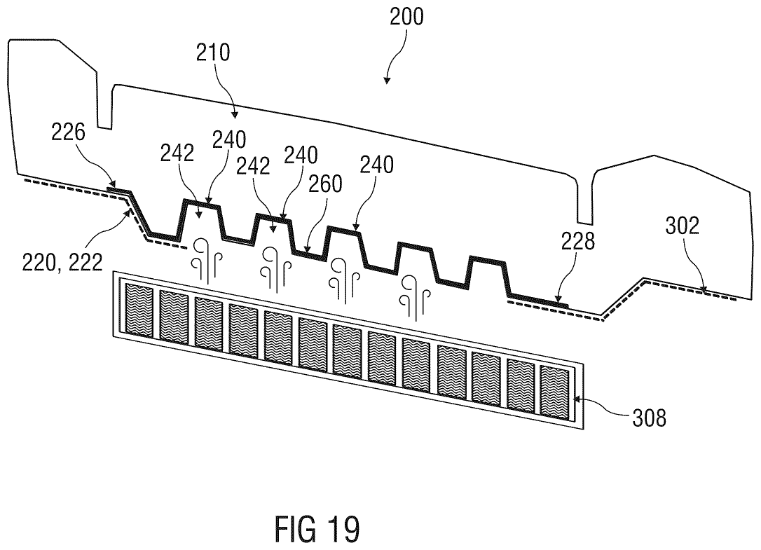

FIG. 19 shows a sectional view of a fifth embodiment of a cushion part 200 comprising a foam body 210 and a textile layer 220. The textile layer 220 may be a three-dimensionally shaped shell fleece. The cushion part 200 is designed as a backrest cushion. Analogously, but not further shown, a seat cushion for a seat part 102 can be configured in the same manner as described below.

The nonwoven textile layer 220 comprises a seating support surface 224, such as a sitting surface or leaning surface, and two side bolsters 226, 228.

The seating support surface 224 comprises a plurality of reinforcement ribs 240.

The reinforcement ribs 240 are formed on the seating support surface 224 of the nonwoven textile layer 220 extending in a transverse direction y. A recess 260 is formed between two adjacent reinforcement ribs 240. The seating support surface 224 comprises a meandering structure 290 extending in the transverse direction y. Said meandering structure 290 comprises alternating reinforcement ribs 240 and recesses 260. Each first receiving spaces 242 of the reinforcement ribs 240 which are open in a direction facing away from the foam body 210 are configured as air-guiding channels for cooling of a battery 308 (such as electric vehicle battery). Further, each of the reinforcement ribs 240 can be substantially U-shaped. By means of the EV battery cooling hot air generated around the battery 308 can be directed through dedicated air-guiding channels integrated in the nonwoven textile layer 220. Thereby, enabling guiding hot air efficiently toward an exhaust outlet. The nonwoven textile layer 220 structurally supports the seat B-surface, avoiding deformation under occupant load while maintaining the geometry of the integrated air channels within the nonwoven textile layer 220.

The foam body 210 and the nonwoven textile layer 220 can be at least partially supported on a frame component 302 and/or a car body.

In accordance with the provisions of the patent statutes, the present device has been described in what is considered to represent its preferred embodiments. However, it should be noted that the device can be practiced otherwise than as specifically illustrated and described without departing from its spirit or scope.

### LIST OF REFERENCES

100 vehicle seat
102 seat part
104 backrest
106 fitting
108 rotational axis
110 longitudinal adjustment device
112 rail arrangement
114 first rail element
116 second rail element
200 cushion part
202 extension direction
204 front-facing side
206 rear-facing side
210 foam body
210.1 thickness
210.2 recess
212 first surface
214 second surface
216 ventilation channel
218 comfort section
220 textile layer
222 support structure layer
224 support surface
226, 228 side bolster
226.1, 228.1 surface, in particular inner surface
226.2, 228.2 surface, in particular outer surface
230 second receiving space
232 inner apex region
240 ribs
242 first receiving space
244 axial end
246 inner apex region
250 stepped portion
252 inner apex region
260 recess
270 leg, in particular first leg
272 leg, in particular second leg
274 ventilation hole
276 web region
280 meandering structure
290 meandering structure
300 functional seat structure
302 frame component
304 airbag module
306 ventilation device
306 blower unit
310 comfort pad
312 spacer
314 mat
316 sealing fleece
x longitudinal direction
y transverse direction
z vertical direction

The invention claimed is:

1. A cushion part for a vehicle seat, comprising:
a foam body having a first surface forming a seating surface and an opposite second surface, and
a three-dimensionally shaped textile layer arranged on the second surface of the foam body and forming a backside of the foam body,
wherein the textile layer comprises a seating support surface and two side bolsters,
wherein a plurality of reinforcement ribs is provided on at least one of a region of the seating support surface, an inner surface of the side bolsters, or an outer surface of the side bolsters, and
each of the reinforcement ribs forms a respective first receiving space.

2. The cushion part of claim 1, wherein at least some of the first receiving spaces formed by the reinforcement ribs are open in a direction facing away from the foam body.

3. The cushion part of claim 1, wherein at least one of the first receiving spaces is open in a direction facing towards the foam body, and wherein the foam body comprises a corresponding recess that is aligned with the first receiving space of the reinforcement rib to jointly form an accommodation space.

4. The cushion part of claim 1, wherein a recess is formed between two adjacent reinforcement ribs.

5. The cushion part of claim 1, wherein at least one of the side bolsters comprises two legs that together enclose a second receiving space.

6. The cushion part of claim 5, wherein at least one of the legs of the at least one side bolster comprises the reinforcement ribs.

7. The cushion part of claim 5, wherein at least one of the legs of the at least one side bolster comprises a meandering structure, wherein the meandering structure comprises alternating reinforcement ribs and recesses.

8. The cushion part of claim 1, wherein the seating support surface comprises a meandering structure extending in a transverse direction and/or vertical direction of the seating support surface, wherein the meandering structure comprises alternating reinforcement ribs and recesses.

9. The cushion part of claim 1, wherein the textile layer comprises at least one ventilation channel configured as a reinforcing air ventilation channel.

10. The cushion part of claim 1, wherein at least one of the reinforcement ribs is U-shaped in cross-section and comprises a ventilation hole formed in a web region of the U-shape, wherein the ventilation hole provides fluid communication between at least one of the first receiving spaces of the reinforcement rib and the foam body and/or a ventilation device.

11. The cushion part of claim 1, wherein the reinforcement ribs have identical or different dimensions in at least one of their length, height, width or thickness.

12. The cushion part of claim 1, wherein the reinforcement ribs are formed integrally with the textile layer during shaping of the textile layer, and wherein the textile layer comprises a three-dimensionally shaped nonwoven support structure layer having a grammage between 450 to 1200 grams per square meter.

13. The cushion part of claim 1, wherein the foam body has a thickness of less than or equal to 30 millimeters at least in a region of the seating support surface and/or the side bolsters of the textile layer.

14. A vehicle seat comprising at least a functional seat structure and the cushion part of claim 1, wherein the functional seat structure is at least partially arranged within at least one of the first or second receiving spaces, and comprises at least one of a frame component, an airbag module, a massage device, a ventilation device or a heating device.

15. The vehicle seat of claim 14, wherein in an assembled state of the functional seat structure and the cushion part, an inner apex region of the first receiving space and/or the second receiving space is in contact with the functional seat structure and/or supported thereon.

16. A cushion part for a vehicle seat, comprising:
a foam body having a first surface forming a seating surface and an opposite second surface, and
a three-dimensionally shaped textile layer arranged on the second surface of the foam body and forming a backside of the foam body;
wherein the textile layer comprises a seating support surface and two side bolsters;
wherein the second surface of the foam body comprises an underside of the foam body.

17. A vehicle seat comprising the cushion part of claim 16 and a ventilation device attached directly to the textile layer.

18. The vehicle seat of claim 17 wherein the textile layer comprises a ventilation channel.

19. A vehicle seat comprising the cushion part of claim 16 and a functional seat component; wherein the textile layer comprises a structure; wherein the functional seat component is attached directly to the structure of the textile layer.

20. The vehicle seat of claim 19 wherein the functional seat component comprises at least one of (a) a blower unit, (b) a lumbar mat, (c) a massage unit.
